(19) United States
(12) Patent Application Publication
(10) Pub. No.: US 2022/0231328 A1
(43) Pub. Date: Jul. 21, 2022

(54) CURRENT COLLECTOR STRUCTURE AND SECONDARY BATTERY HAVING THE SAME

(71) Applicant: HONDA MOTOR CO., LTD., Tokyo (JP)

(72) Inventors: Toshiyuki ARIGA, Saitama (JP); Takuya TANIUCHI, Saitama (JP); Masahiro OHTA, Saitama (JP)

(21) Appl. No.: 17/572,527

(22) Filed: Jan. 10, 2022

(30) Foreign Application Priority Data
Jan. 15, 2021 (JP) 2021-004608

(51) Int. Cl. H01M 10/0562; H01M 50/533; H01M 10/0585; H01M 4/66; H01M 4/76; H01M 10/0525

(52) U.S. Cl. CPC H01M 10/0562; H01M 50/533; H01M 10/0585; H01M 2004/021; H01M 4/762; H01M 10/0525; H01M 4/661

(57) ABSTRACT

To prevent the breakage of a bonding portion when current collector tabs are converged and bonded, and thereby maintain a current path. A plurality of electrode current collectors each including a metal porous body, a plurality of tabs each extending from an end of the metal porous body of each of the electrode current collectors, and a connecting tab lead that electrically connects the tabs, are included. The connecting tab lead is cross-bonded with each of the tabs to form a first compression bonding portion, and is further folded from a first of the tabs to a second of the tabs, for example, the connecting tab lead is arranged in a bellows shape. At a tab convergence location where the first compression bonding portions are stacked, the tabs are converged by forming a second compression bonding portion by ultrasonic waves or other means.

This application is based on and claims the benefit of priority from Japanese Patent Application No. 2021-004608, filed on 15 Jan. 2021, the content of which is incorporated herein by reference.

### BACKGROUND OF THE INVENTION

### Field of the Invention

The present invention relates to a current collector structure and a secondary battery having the same.

### Related Art

Conventionally, lithium ion secondary batteries have been widely used as secondary batteries having a high energy density. A liquid lithium ion secondary battery has a cell structure in which a separator is present between a positive electrode and a negative electrode and the cell is filled with a liquid electrolyte (electrolytic solution). In the case of a solid-state battery where the electrolyte is solid, the battery has a cell structure in which a solid electrolyte is present between a positive electrode and a negative electrode. A plurality of the cells are stacked on one another to construct a solid lithium ion secondary battery.

It has been proposed to use metal porous bodies as current collectors constituting a positive electrode and a negative electrode (for example, see Patent Document 1). The metal porous body has a network structure with pores and a large surface area. The amount of an electrode active material per unit area of the electrode layer can be increased by filling the interior of the network structure with an electrode material mixture containing the electrode active material.

As a method of increasing the connection strength between metal porous bodies included in an electrode, an electrode in which another metal porous body is placed between end portions of metal porous bodies and the three metal porous bodies are collectively pressure-bonded is known (for example, see Patent Document 2).
Patent Document 1: Japanese Unexamined Patent Application, Publication No. 2012-186139
Patent Document 2: Japanese Unexamined Patent Application, Publication No. 2004-063398

### SUMMARY OF THE INVENTION

FIG. 7 is a perspective view of an embodiment of a secondary battery having a conventional current collector structure. FIG. 8 is a perspective view of the secondary battery before convergence of tabs. FIG. 9 is a cross-sectional view of the vicinity of a tab convergence portion in FIG. 7. FIG. 10 is an enlarged cross-sectional view of the vicinity of the tab convergence portion in FIG. 9.

As shown in FIG. 7, a secondary battery 200 is an electrode stack in which a positive electrode 10 and a negative electrode 20 are alternately stacked with a solid electrolyte layer 30 provided therebetween. A positive electrode tab 11 extends from the positive electrode 10, and a negative electrode tab 21 extends from the negative electrode 20. The positive electrode 10 and the negative electrode 20 are each formed entirely of a metal porous body. Each of the electrodes includes an electrode material mixture filled region that is filled with an electrode material mixture and an electrode material mixture non-filled region that is not filled with the electrode material mixture. The positive electrode tab 11 and the negative electrode tab 21 constitute the electrode material mixture non-filled regions. The positive electrode tabs 11 and the negative electrode tabs 21 are each converged to form a bonding portion 60. It should be noted that FIG. 7 shows only the convergence state of the positive electrode tabs 11 and omits the convergence state of the negative electrode tabs 21. The negative electrode tabs are similarly converged.

FIG. 8 shows a state before the convergence of the tabs in FIG. 7. From this state, as shown in FIG. 9, end portions of the positive electrode tabs 11 and end portions of the negative electrode tabs 21 are respectively converged and compression bonded by ultrasonic welding, resistance welding, or other means. An enlarged view of the bonding portion 60 at this time is shown in FIG. 10. In the bonding portion 60, a plurality of the positive electrode tabs 11 are stacked (three tabs in this embodiment).

The metal porous body constituting the tabs normally has a porosity of 90 volume % or more. Thus, when the tabs are compression bonded, the thickness of the boding portion is reduced to about one tenth of the original thickness (d₀>d₁). In this case, a large step (thickness difference) is generated between the bonding portion 60 and the surrounding area. Thus, the positive electrode tabs 11 are pushed and cut by a pressure member such as an ultrasonic horn on the upper side of the bonding portion 60 in FIG. 10, and in particular, the positive electrode tab 11 at the upper part of the stack is easily broken.

In response to the above issue, it is an object of the present invention to prevent the breakage of a bonding portion when current collector tabs are converged and bonded, and thereby maintain a current path.

The present inventors have found that the above issue can be solved by arranging a connecting tab lead spanning between the tabs in a specific state, and completed the present invention. That is, the present invention provides the following.

(1) A first aspect of the present invention relates to a current collector structure. The current collector structure includes a plurality of electrode current collectors each including a metal porous body,

a plurality of tabs each extending from an end of the metal porous body of each of the electrode current collectors, and a connecting tab lead that electrically connects two or more of the tabs. The connecting tab lead includes a metal porous body. The connecting tab lead and each of the tabs have a first compression bonding portion at an intersection where an extending direction of each of the tabs and a longitudinal direction of the connecting tab lead intersect each other. The connecting tab lead is arranged to be folded from the intersection with a first of the tabs and extend to the intersection with a second of the tabs. The current collector structure has a second compression bonding portion at a tab convergence location where a plurality of the intersections are stacked.

According to the invention of the first aspect, a tab and a connecting tab lead are present in the first compression bonding portion and tabs and a connecting tab lead are present in the second compression bonding portion. Accordingly, the density of each of the metal porous bodies in each of the compression bonding portions is increased because the tab(s) and the connecting tab lead intertwine with each other to form each of the compression bonding portions. This can effectively prevent the breakage of the bonding portion.

(2) in a second aspect of the present invention according to the first aspect, the current collector structure is connected to a tab for external connection at the second compression bonding portion.

According to the invention of the second aspect, the second compression bonding portion allows the current collector structure to be bonded to the tab for external connection without breakage of the tabs.

(3) A third aspect of the present invention relates to a secondary battery having the current collector structure according to the first or second aspect. The secondary battery includes a positive electrode and/or a negative electrode each having an electrode material mixture filled region that is filled with an electrode material mixture and an electrode material mixture non-filled region that is not filled with the electrode material mixture, within the metal porous body of each of the electrode current collectors, and

an electrolyte disposed between the positive electrode and the negative electrode. The electrode material mixture non-filled region of each of the electrode current collectors constitutes one of the tabs.

According to the invention of the third aspect, it is possible to obtain a secondary battery achieving the effect of the first or second aspect.

### BRIEF DESCRIPTION OF THE DRAWINGS

FIG. 1 is a perspective view showing an embodiment of a secondary battery having a current collector structure of the present invention;

FIG. 2 is a plan view showing a state in which a plurality of tabs extending from electrodes are connected with a connecting tab lead;

FIG. 3 is a perspective view of the secondary battery before the convergence of the tabs in FIG. 1;

FIG. 4 is an enlarged perspective view of the vicinity of the tabs in FIG. 3;

FIG. 5A is a cross-sectional schematic diagram showing the arrangement of the connecting tab lead and a modification thereof;

FIG. 5B is a cross-sectional schematic diagram showing the arrangement of the connecting tab lead and a modification thereof;

FIG. 5C is a cross-sectional schematic diagram showing the arrangement of the connecting tab lead and a modification thereof;

FIG. 6 is an enlarged cross-sectional view of a tab convergence portion in FIG. 1;

FIG. 7 is a perspective view of an embodiment of a secondary battery having a conventional current collector structure;

FIG. 8 is a perspective view of the secondary battery before the convergence of tabs in FIG. 7;

FIG. 9 is a cross-sectional view of the vicinity of a tab convergence portion in FIG. 7; and

FIG. 10 is an enlarged cross-sectional view of the vicinity of the tab convergence portion in FIG. 9.

### DETAILED DESCRIPTION OF THE INVENTION

An embodiment of the present invention will now be described with reference to the drawings. The present invention is not limited to the following embodiment. In the following embodiment, a solid-state lithium ion battery will be used as an example, but the present invention is not limited to solid-state batteries and can be applied to secondary batteries including a liquid electrolyte and a separator. The present invention can also be applied to batteries other than lithium ion batteries.

### First Embodiment

### <Overall Structure of Lithium Ion Secondary Battery>

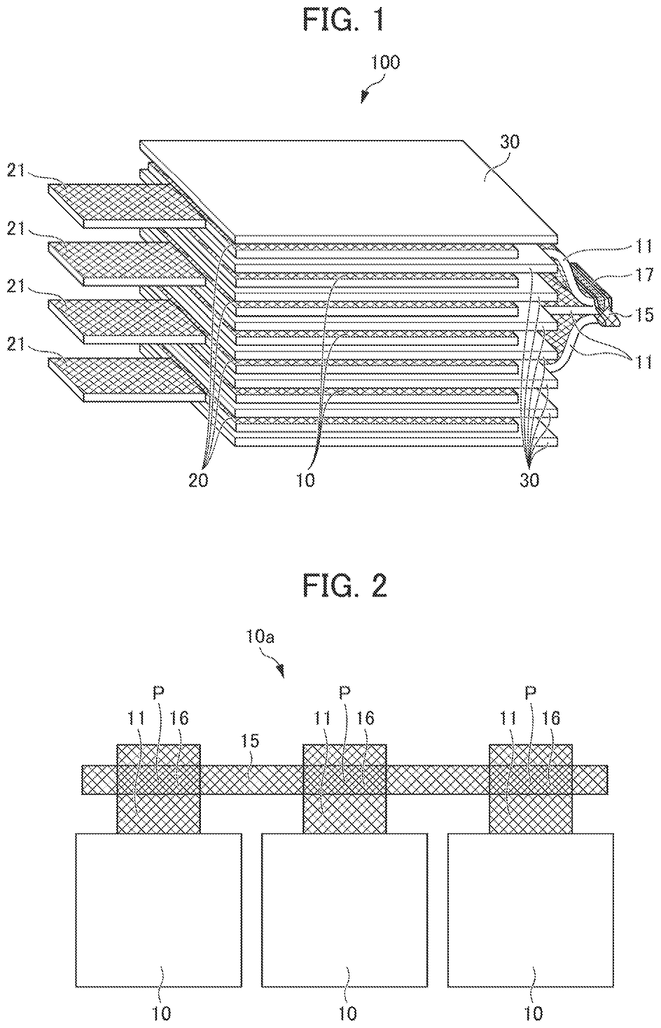

As shown in FIG. 1, a lithium ion secondary battery 100 according to the present embodiment is a solid-state battery, and is an electrode stack in which a positive electrode 10 and a negative electrode 20 are alternately arranged with a solid electrolyte layer 30 provided therebetween. Although not shown in the drawing, the electrode stack including the tabs and tab convergence portions described below is vacuum packaged in an outer packaging film. The lead tabs of the positive and negative electrodes respectively electrically connected to the tab convergence portions extend toward the outside of the outer packaging film.

Specifically, positive electrode tabs 11 respectively extend from ends of the current collectors of the corresponding electrodes of the electrode stack and then converge, and are compression bonded at a second compression bonding portion 17 to be integrated. Similarly, negative electrode tabs 21 respectively extend from ends of the current collectors of the corresponding electrodes of the electrode stack and then converge, and are compression bonded at a second compression bonding portion 17 to be integrated. A tab for external connection 50 is electrically connected to the second compression bonding portion 17 (see FIG. 6). The details of this current collector structure will be described later.

The respective components will be described.

### <Positive Electrode and Negative Electrode>

In this embodiment, the positive electrode 10 and the negative electrode 20 each include a current collector including a metal porous body having pores that are continuous with each other (communicating pores).

The pores of each current collector are filled with an electrode material mixture (positive electrode material mixture or negative electrode material mixture) containing an electrode active material, which is a region that is filled with the electrode material mixture. Conversely, the positive electrode tab 11 and the negative electrode tab 21 are regions that are not respectively filled with the electrode material mixtures.

### (Current Collector)

The current collector includes a metal porous body having pores that are continuous with each other. Having pores that are continuous with each other allows the pores to be filled with a positive electrode material mixture or a negative electrode material mixture containing an electrode active material, thereby increasing the amount of the electrode active material per unit area of the electrode layer. The form of the metal porous body is not limited as long as it has pores that are continuous with each other. Examples of the form of the metal porous body include a foam metal having pores by foaming, a metal mesh, an expanded metal, a punching metal, and a metal nonwoven fabric.

The metal used in the metal porous body is not limited as long as it has electric conductivity. Examples thereof include nickel, aluminum, stainless steel, titanium, copper, and silver. Among these, as the current collector constituting the positive electrode, for a battery including a solid electrolyte, a foamed aluminum, foamed nickel, and foamed stainless steel are preferable, and for a battery including an electrolytic solution, a foamed aluminum is preferable. As the current collector constituting the negative electrode, regardless of whether the battery includes a solid electrolyte or an electrolytic solution, a foamed copper, foamed nickel, and foamed stainless steel are preferable.

By using the current collector including the metal porous body, the amount of the active material per unit area of the electrode can be increased, and as a result, the volumetric energy density of the lithium ion secondary battery can be improved. In addition, since the positive electrode material mixture and the negative electrode material mixture are easily fixed, it is not necessary to thicken a coating slurry for forming the electrode material mixture layer when the electrode material mixture layer is thickened, unlike a conventional electrode including a metal foil as a current collector. Accordingly, it is possible to reduce a binder such as an organic polymer compound that has been necessary for thickening. Therefore, the capacity per unit area of the electrode can be increased, and a higher capacity of the lithium ion secondary battery can be achieved.

### (Electrode Material Mixture)

The positive electrode material mixture and the negative electrode material mixture are respectively disposed in the pores formed within the current collectors. The positive electrode material mixture and the negative electrode material mixture respectively contain a positive electrode active material and a negative electrode active material as an essential component.

### (Electrode Active Material)

The positive electrode active material is not limited as long as it can occlude and release lithium ions. Examples thereof include LiCoO₂, Li(Ni_{6/10}Co_{2/10}Mn_{3/10})O₂, Li(Nd_{8/10}Co_{2/10}Mn_{2/10})O₂, Li(Ni_{8/10}Co_{1/10}Mi_{1/10})O₂, Li(N_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, Li(Ni_{1/3}Co_{1/3}Mn_{1/3})O₂, LiCoO₄, LiMn₂O₄, LiNiO₂, LiFePO₄, lithium sulfide, and sulfur.

The negative electrode active material is not limited as long as it can occlude and release lithium ions. Examples thereof include metallic lithium, lithium material mixtures, metal oxides, metal sulfides, metal nitrides, Si, SiO, and carbon materials such as artificial graphite, natural graphite, hard carbon, and soft carbon.

### (Other Components)

The electrode material mixture may optionally include components other than an electrode active material and ionic conductive particles. The other components are not limited, and can be any components that can be used in fabricating a lithium ion secondary battery. Examples thereof include a conductivity aid and a binder. The conductivity aid of the positive electrode is, for example, acetylene black, and the binder of the positive electrode is, for example, polyvinylidene fluoride. Examples of the binder of the negative electrode include sodium carboxyl methyl cellulose, styrene-butadiene rubber, and sodium polyacrylate.

### (Method for Manufacturing Positive Electrode and Negative Electrode)

The positive electrode 10 and the negative electrode 20 are each obtained by filling pores that are continuous with each other of a metal porous body as a current collector with an electrode material mixture. First, an electrode active material and, if necessary, a binder and a conductivity aid, are uniformly mixed by a conventionally known method, and thus an electrode material mixture composition adjusted to a predetermined viscosity, preferably in the form of a paste, is obtained.

Subsequently, pores of a metal porous body, which is a current collector, are filled with the above electrode material mixture composition as an electrode material mixture. The method of filling the current collector with the electrode material mixture is not limited, and is, for example, a method of filling the pores of the current collector with a slurry containing the electrode material mixture by applying pressure using a plunger-type die coater. As an alternative, the interior of the metal porous body may be impregnated with an ion conductor layer by a dipping method.

### <Solid Electrolyte Layer>

As shown in FIG. 1, in the present invention, a solid electrolyte layer 30 is formed between the positive electrode 10 and the negative electrode 20.

The solid electrolyte constituting the solid electrolyte layer 30 is not limited, and is, for example, a sulfide solid electrolyte material, an oxide solid electrolyte material, a nitride solid electrolyte material, or a halide solid electrolyte material. Examples of the sulfide solid electrolyte material include LPS halogens (Cl, Br, and I), Li₂S—P₂S₆, and Li₂S—P₂S₅—LiI for lithium ion batteries. The above-described “Li₂S—P₂S₅” refers to a sulfide solid electrolyte material including a raw material composition containing Li₂S and P₂S₅, and the same applies to the “Li₂S—P₂S₅—LiI”. Examples of the oxide solid electrolyte material include NASICON-type oxides, garnet-type oxides, and perovskite-type oxides for lithium ion batteries. Examples of the NASICON-type oxides include oxides containing Li, Al, Ti, P, and O (e.g., Li_{1.5}Al_{0.5}Ti_{1.5}(PO₄)₃). Examples of the garnet-type oxides include oxides containing Li, La, Zr, and O (e.g., Li₇La₃Zr₂O₁₂). Examples of the perovskite-type oxides include oxides containing Li, La, Ti, and O (e.g., LiLaTiO₃).

### <Liquid Electrolyte>

The electrolyte dissolved in the non-aqueous solvent is not limited, and is, for example, LiPF₆, LiBF₄, LiClO₄, LiN(SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃N, Li₃P, Li₁₀GeP₂S₁₂ (LGPS), Li₃PS₄, Li₆PS₅Cl, Li₇P₂S₃I, LiₓPO_{y}N_{z} (x=2y+3z−5, LiPON), Li₇La₃Zr₂O₁₂ (LLZO), Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+z+y}AlₓTi₂₋ₓSiyP_{3-y}O₁₂, Li_{1+z+y}Al_{z}(Ti,Ge)₂₋ₓSiyP_{3-y}O₁₂, and Li₄₋₂ₓZnₓGeO₄ (LISICON). One of the above may be used alone, or two or more of the above may be used in combination.

The non-aqueous solvent included in the electrolytic solution is not limited, and examples thereof include aprotic solvents such as carbonates, esters, ethers, nitriles, sulfones, and lactones. Specifically, ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, γ-butyrolactone, and the like may be used. One of the above may be used alone, or two or more of the above may be used in combination.

### (Separator)

The lithium ion secondary battery of this embodiment may include a separator, especially when a liquid electrolyte is used. The separator is located between the positive electrode and the negative electrode. The material and thickness of the separator are not limited, and any known separator that can be used for lithium ion secondary batteries, such as polyethylene or polypropylene, can be applied.

### <Current Collector Structure>

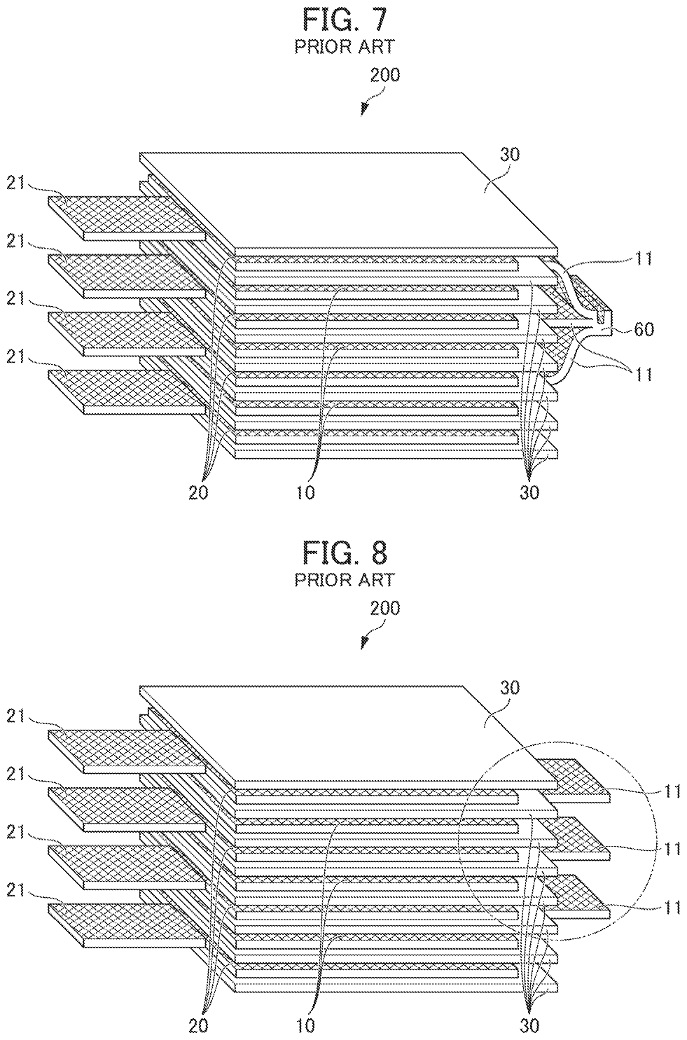

The current collector structure, which is a feature of the present invention, will be specifically described with reference to FIGS. 1 to 6. The same components as those of the conventional technology in FIGS. 7 to 10 are designated by the same reference numerals, and the description thereof will be omitted.

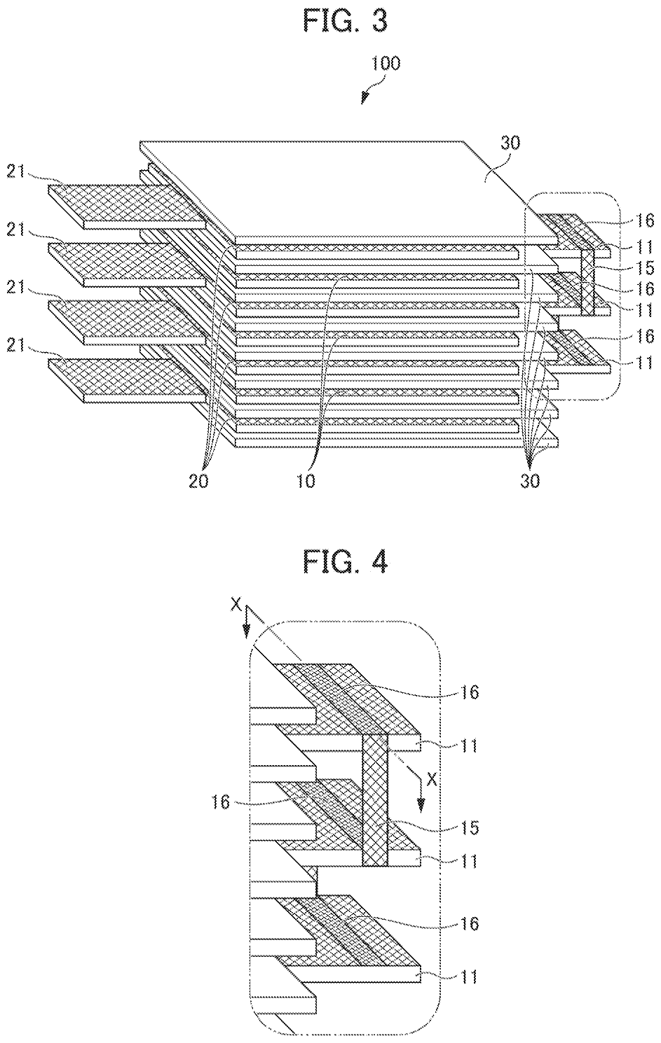

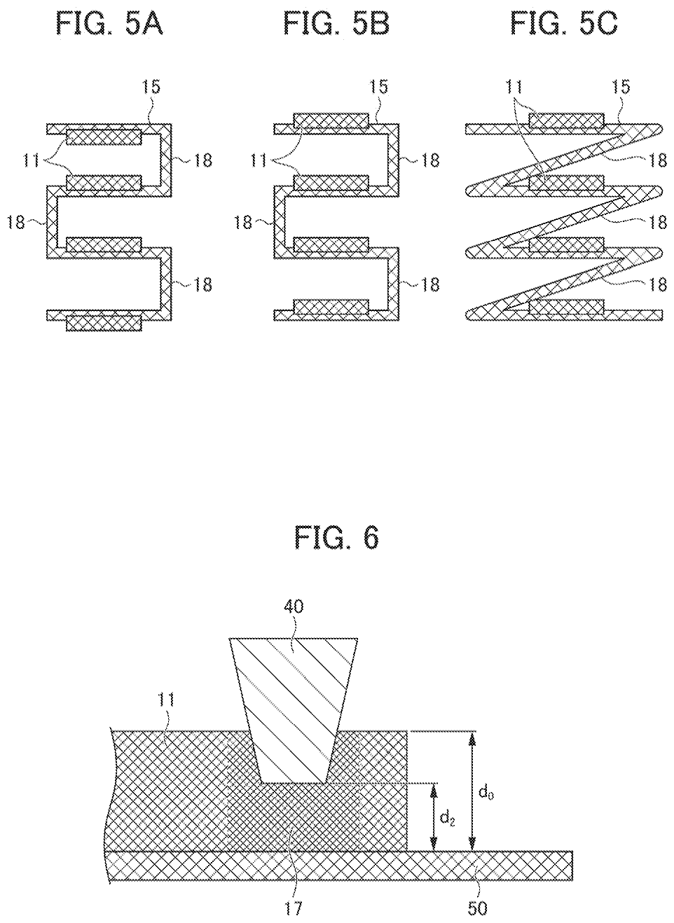

FIG. 1 is a perspective view showing an embodiment of a secondary battery having the current collector structure of the present invention. FIG. 2 is a plan view showing a state in which a plurality of tabs extending from electrodes are connected with a connecting tab lead. FIG. 3 is a perspective view of the secondary battery before the convergence of the tabs in FIG. 1. FIG. 4 is an enlarged perspective view of the vicinity of the tabs in FIG. 3. FIG. 5 is a cross-sectional schematic diagram showing the arrangement of the connecting tab lead and a modification thereof. FIG. 6 is an enlarged cross-sectional view of a tab convergence portion in FIG. 1.

As shown in FIG. 1, this lithium ion secondary battery 100 is an electrode stack in which the positive electrode 10 and the negative electrode 20 are alternately stacked with the solid electrolyte layer 30 provided therebetween. The positive electrode tab 11 is extended from the positive electrode 10, and the negative electrode tab 21 is extended from the negative electrode 20. The positive electrode 10 and the negative electrode 20 are each formed entirely of a metal porous body. Each of the electrodes includes an electrode material mixture filled region that is filled with an electrode material mixture and an electrode material mixture non-filled region that is not filled with the electrode material mixture. The positive electrode tab 11 and the negative electrode tab 21 constitute the electrode material mixture non-filled regions. The positive electrode tabs 11 and the negative electrode tabs 21 are each converged to form a second compression bonding portion 17. It should be noted that FIG. 1 shows only the convergence state of the positive electrode tabs 11 and omits the convergence state of the negative electrode tabs 21. The negative electrode tabs 21 are similarly converged. The current collector structure of the positive electrode 10 is described below, and the negative electrode 20 has the same structure.

FIG. 2 is a plan view in which a connecting member 10a including the positive electrodes 10 and a connecting tab lead 15 in FIG. 1 is extracted and unfolded.

The positive electrode tab 11 that extends from a side of the positive electrode 10 of a substantially rectangular shape and that has a narrower width than the side of the positive electrode 10 is also of a rectangular shape. As described above, the positive electrode tab 11 is an electrode material mixture non-filled region of the metal porous body.

The connecting tab lead 15 is a separate body from the positive electrode tab 11, but includes a similar metal porous body (the material and size thereof may be different from those of the positive electrode tab 11). The connecting tab lead 15 has a flat plate shape (lead shape) of a predetermined width as a whole in plan view, and has a longitudinal direction and a width direction. In this embodiment, the extending direction of the positive electrode tab 11 is substantially orthogonal to the longitudinal direction of the connecting tab lead 15. The positive electrode tab 11 and the connecting tab lead 15 overlap with each other at a position including the extending end portion of the positive electrode tab 11, forming an intersection P. The “intersection” in the present invention means that they at least partially overlap with each other, as shown in FIG. 2, and they may intersect with each other.

At three intersections P in FIG. 2, the connecting tab lead 15 and each of the positive electrode tabs 11 form a first compression bonding portion 16, whereby the connecting tab lead 15 is electrically bonded to the positive electrode tabs 11. As a result, even if the positive electrode tab 11 is broken at a specific point, the overall electrical continuity is secured. In the first compression bonding portion 16, the metal porous bodies of the two are intertwined with each other since they engage with each other and are pressure-bonded, thereby ensuring reliable bonding both electrically and physically. The first compression bonding portion 16 can be formed by a conventionally known pressing process.

FIG. 3 is a diagram in which the connecting member 10a in FIG. 2 is folded and arranged to form an electrode stack, and shows a state before the convergence of the tabs in FIG. 1. FIG. 4 is an enlarged view of FIG. 3. In FIGS. 3 and 4, the connecting tab lead 15 is arranged with four folds. The connecting tab lead 15 is extended from one side of a first positive electrode tab 11 of the uppermost layer in the stacked state to one side of a second positive electrode tab 11 of the middle layer and is folded via a folding portion 18. Then, the connecting tab lead 15 is extended from the other side of the second positive electrode tab 11 to the other side of a third positive electrode tab 11 of the lowermost layer and is folded via a folding portion 18.

FIG. 5 is a schematic diagram of a cross-sectional view taken from line X-X in FIG. 4, and shows an example of a folded state. In the present invention, the form of folding is not limited, and may be folded in a bellows shape, as shown in FIGS. 5A and 5B, or in a Z shape, as shown in FIG. 5C. The number of folds is not limited, as long as the connecting tab lead 15 connects two or more positive electrode tabs 11. In other words, all tabs may be converged collectively or divided and converged.

The positional relationship between the connecting tab lead 15 and the positive electrode tab 11 is also not limited. As shown in FIGS. 5A and 5B, the positive electrode tab 11 may form the first compression bonding portion 16 on the upper surface of the connecting tab lead 15 or on the lower surface of the connecting tab lead 15.

From the state shown in FIG. 3, as shown in FIG. 6, the end portions of the positive electrode tabs 11 and the end portions of the negative electrode tabs 21 are converged respectively. At the convergence position of the tabs, the tabs are stacked so that the respective first compression bonding portions 16 of the tabs overlap with one another. At that position, the tabs are compression bonded by ultrasonic welding, resistance welding, or other means to form the second compression bonding portion 17, which is bonded to the tab for external connection 50. Thus, the lithium ion secondary battery 100 in FIG. 1 is obtained. FIG. 6 is an enlarged view of the vicinity of the second compression bonding portion 17 at this time.

In this second compression bonding portion 17, a plurality of bonding portions each composed of the connecting tab lead 15 and the positive electrode tab 11 that have the first compression bonding portion 16 described above overlap and are stacked (in this embodiment, a total of three layers), and are compression bonded by an ultrasonic horn 40. Similarly to the first compression bonding portion 16, in the second compression bonding portion 17, the metal porous bodies of the bonding portions are intertwined with each other since they engage with each other and are pressure-bonded, thereby ensuring reliable bonding both electrically and physically.

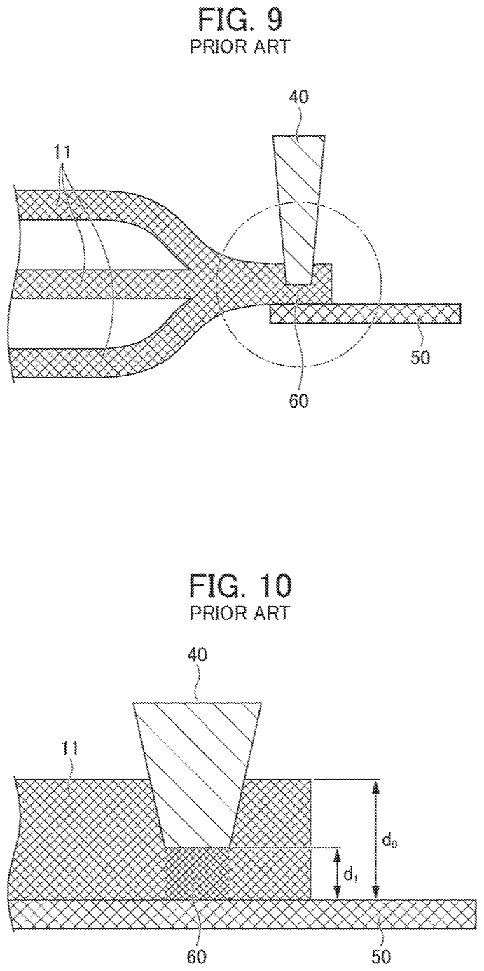

In the conventional technology shown in FIGS. 9 and 10, a bonding portion 60 is composed of only three positive electrode tabs. In contrast, in the second compression bonding portion 17 of the present embodiment, the connecting tab lead 15 and the positive electrode tab 11 form the first compression bonding portion 16 in advance, and three of these overlap with one another, so that substantially a total of six pieces are alternately stacked. Therefore, the thickness d₂ in FIG. 6 is greater than the thickness d₁ in FIG. 10 (d₂>d₁). In addition, since the first compression bonding portions 16 are formed beforehand, the density of each of the metal porous bodies is increased, and thus the breakage strength is already increased. This can effectively prevent the breakage of the tabs during ultrasonic or resistance welding.

Before forming the second compression bonding portion 17, another pressing process may be performed at the tab convergence position to obtain a bonding surface with the tab for external connection 50. In this case, in plan view, the pressing area of the other pressing process is preferably greater than the bonding area of the first compression bonding portion 16. This eliminates a step in the bonding portion caused by the presence of the first compression bonding portions 16 and provides a smooth bonding surface. Thus, bonding to the tab for external connection 50 is ensured.

Although a preferred embodiment of the present invention has been described above, the present invention is not limited to the above embodiment and can be modified as appropriate.

### EXPLANATION OF REFERENCE NUMERALS

10 positive electrode
10a connecting member
11 positive electrode tab
15 connecting tab lead
16 first compression bonding portion
17 second compression bonding portion
18 folding portion
20 negative electrode
21 negative electrode tab
40 ultrasonic horn
50 tab for external connection
100 lithium ion secondary battery

What is claimed is:

1. A current collector structure, comprising:
a plurality of electrode current collectors each comprising a metal porous body;
a plurality of tabs each extending from an end of the metal porous body of each of the electrode current collectors; and
a connecting tab lead that electrically connects two or more of the tabs,
the connecting tab lead comprising a metal porous body,
the connecting tab lead and each of the tabs having a first compression bonding portion at an intersection where an extending direction of each of the tabs and a longitudinal direction of the connecting tab lead intersect each other,
the connecting tab lead being arranged to be folded from the intersection with a first of the tabs and extend to the intersection with a second of the tabs, and
the current collector structure having a second compression bonding portion at a tab convergence location where a plurality of the intersections are stacked.

2. The current collector structure according to claim 1, wherein the current collector structure is connected to a tab for external connection at the second compression bonding portion.

3. A secondary battery having the current collector structure according to claim 1, the secondary battery comprising:
a positive electrode and/or a negative electrode each having an electrode material mixture filled region that is filled with an electrode material mixture and an electrode material mixture non-filled region that is not filled with the electrode material mixture, within the metal porous body of each of the electrode current collectors; and
an electrolyte disposed between the positive electrode and the negative electrode,
the electrode material mixture non-filled region of each of the electrode current collectors constituting one of the tabs.

4. A connecting member, comprising:
a plurality of electrode current collectors each comprising a metal porous body;
a plurality of tabs each extending from an end of the metal porous body of each of the electrode current collectors; and
a connecting tab lead that electrically connects two or more of the tabs,
the connecting tab lead comprising a metal porous body,
the connecting tab lead and each of the tabs having a first compression bonding portion at an intersection where an extending direction of each of the tabs and a longitudinal direction of the connecting tab lead intersect each other, and
the connecting tab lead being arranged to be folded from the intersection with a first of the tabs and extend to the intersection with a second of the tabs.
